(19) United States
(12) Patent Application Publication
(10) Pub. No.: US 2020/0141969 A1
(43) Pub. Date: May 7, 2020

(54) SYSTEM AND METHOD FOR DETERMINING AIRSPEED

(71) Applicant: SZ DJI TECHNOLOGY CO., LTD., Shenzhen (CN)

(72) Inventors: Fu ZHANG, Shenzhen (CN); Zhimeng SHANG, Shenzhen (CN)

(21) Appl. No.: 16/721,002

(22) Filed: Dec. 19, 2019

Related U.S. Application Data
(63) Continuation of application No. PCT/CN2017/103725, filed on Sep. 27, 2017.

(51) Int. Cl. G01P 21/02; G05D 1/02; G01P 1/12; B64C 39/02; G01P 5/02; B64D 43/02

(52) U.S. Cl. CPC G01P 21/025; G05D 1/0202; G01P 1/122; B64C 2201/165; G01P 5/02; B64D 43/02; B64C 39/024

(57) ABSTRACT

A method of determining airspeed of a movable object includes performing a calibration process to determine a relationship between forces exerted on the movable object and airspeed of the movable object, determining forces exerted on the movable object while the movable object is moving, and determining an airspeed of the movable object based on the determined forces and the relationship.

### CROSS-REFERENCE TO RELATED APPLICATION

This application is a continuation of International Application No. PCT/CN2017/103725, filed Sep. 27, 2017, the entire content of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the patent and trademark office patent file or records, but otherwise reserves all copyright rights whatsoever.

### TECHNICAL FIELD

The present disclosure relates generally to flight instrumentation and, more particularly, to systems and methods of determining the airspeed of an airborne object.

### BACKGROUND

Unmanned aerial vehicles (“UAV”), sometimes referred to as “drones,” include pilotless aircraft of various sizes and configurations that can be remotely operated by a user or programmed for automated flight. UAVs can be used for many purposes and are often used in a wide variety of personal, commercial, and tactical applications. For instance, UAVs can be equipped with imaging equipment, such as cameras, video cameras, etc. UAVs equipped with imaging devices find particular use in the surveillance, national defense, and professional videography industries, among others, besides being popular with hobbyists and for recreational purposes.

The flight characteristics of UAVs, similar to other aerial vehicles such as manned aircrafts and helicopters, highly depend on the speed of the UAVs relative to air (airspeed). For example, a fixed-wing UAV must be controlled to fly at or above a certain threshold airspeed, so that the wings of the UAV can generate sufficient lift to keep the UAV airborne. A multi-copter UAV must be controlled to fly below a maximum safe forward airspeed, to avoid unwanted conditions such as retreating blade stalls. Therefore, accurate determination of airspeed is necessary for safe and effective operation of a UAV.

With conventional technologies, the airspeed of a UAV can be estimated based on a lookup table that maps an attitude of the UAV (which indicates an orientation of the UAV relative to a horizontal plane, and can include a yaw angle, a pitch angle, and a roll angle relative to the horizontal ground) to a horizontal airspeed. The lookup table is typically created during a calibration process in which the UAV flies at a fixed altitude and at a predetermined attitude, at a steady speed, and in an environment where there is no air current (e.g., a fully-enclosed indoor environment). When no wind is present, the UAV's ground speed is considered to be its horizontal airspeed. The UAV's ground speed can be determined based on a change in the UAV's horizontal location measured with a Global Positioning System (GPS). The lookup table is created after repeated tests with different attitudes to reflect the correspondence between attitude and airspeed (or ground speed). In operation, the lookup table is used to estimate the UAV's airspeed based on its attitude.

This conventional approach has limits. First, the lookup table, being generated in a windless environment, does not accurately reflect the relationship between attitude and airspeed in an environment with wind, e.g., an outdoor environment. Second, the lookup table only reflects the correspondence between attitude and steady airspeed. In other words, it fails to indicate the airspeed before the UAV reaches the steady speed at a certain attitude. For example, the lookup table cannot be used to estimate the interim airspeed when the UAV is climbing, descending, accelerating, or decelerating.

Accordingly, there is need to provide improved estimation of airspeed, hence improved flight operations.

### SUMMARY

Consistent with the present disclosure, there is provided a method of determining airspeed of a movable object. The method includes a calibration process to determine a relationship between forces exerted on the movable object and airspeed of the movable object. Forces exerted on the movable object while the movable object is moving are determined, and the airspeed of the movable object is determined based on the determined forces and the relationship.

Consistent with the present disclosure, there is provided a movable object that includes a memory storing a relationship between airspeeds and forces exerted on the movable object; a first sensor that senses forces exerted on the movable object; and a processor configured to determine an airspeed of the movable object based on the relationship and the sensed forces on the movable object.

Consistent with the present disclosure, there is also provided a movable object that includes one or more propellers; an electronic speed control module configured to determine rotational speeds of the one or more propellers; an accelerometers configured to detect one or more forces received by the movable object; an attitude detection unit that includes at least one of a magnetometer, a gyroscope, or an inertial measurement unit; a barometer configured to provide information for determination of air density; a memory storing a relationship between airspeeds and forces exerted on the movable object; and a processor configured to determine an airspeed of the movable object based on the relationship, the detected forces, the rotation speeds, an attitude detected by the attitude detection unit.

It is to be understood that both the foregoing general description and the following detailed description are exemplary and explanatory only and are not restrictive of the disclosed embodiments as defined in the claims.

### BRIEF DESCRIPTION OF DRAWINGS

The accompanying drawings, which are incorporated in and constitute a part of this specification, illustrate several embodiments and, together with the description, serve to explain the disclosed principles. In the drawings:

FIG. 1 illustrates a use case in which exemplary embodiments of the present disclosure can be used.

FIG. 2 illustrates a method of determining airspeed of an airborne object, according to embodiments of the present disclosure.

FIGS. 3 and 4 are schematic diagrams of an exemplary system for determining airspeed of an airborne object, according to embodiments of the present disclosure.

FIGS. 5A-5C are flowcharts illustrating an exemplary sequence of steps that may be performed for determining for determining airspeed of an airborne object, according to embodiments of the present disclosure.

FIG. 6 is a schematic diagram of an exemplary system for determining airspeed of an airborne object, according to embodiments of the present disclosure.

### DETAILED DESCRIPTION

The disclosed embodiments provide improved techniques for flight instrumentation and, more particularly, systems and methods of determining the airspeed of an airborne object based on the ground speed of the airborne object, and one or more forces received by the airborne object. The resulting systems and methods provide enhanced accuracy, usability, and robustness in their ability to determine the airspeed of an airborne object operating under different environments and in different flight states.

Reference will now be made in detail to exemplary disclosed embodiments, examples of which are illustrated in the accompanying drawings and disclosed herein. Where convenient, the same reference numbers will be used throughout the drawings to refer to the same or like parts.

Embodiments are provided below using UAVs as exemplary movable objects. As used herein, the term UAV may refer to an aerial device configured to be operated and controlled autonomously (i.e., via an electronic control system) and/or manually by off-board personnel. It will also be understood that other types of airborne movable objects may also or alternatively be used in embodiments consistent with this disclosure. For example, embodiments presented herein should apply to any suitable movable object, device, mechanism, system, or machine configured to travel on or within a suitable medium (e.g., a surface, air, water, rails, space, underground, etc.).

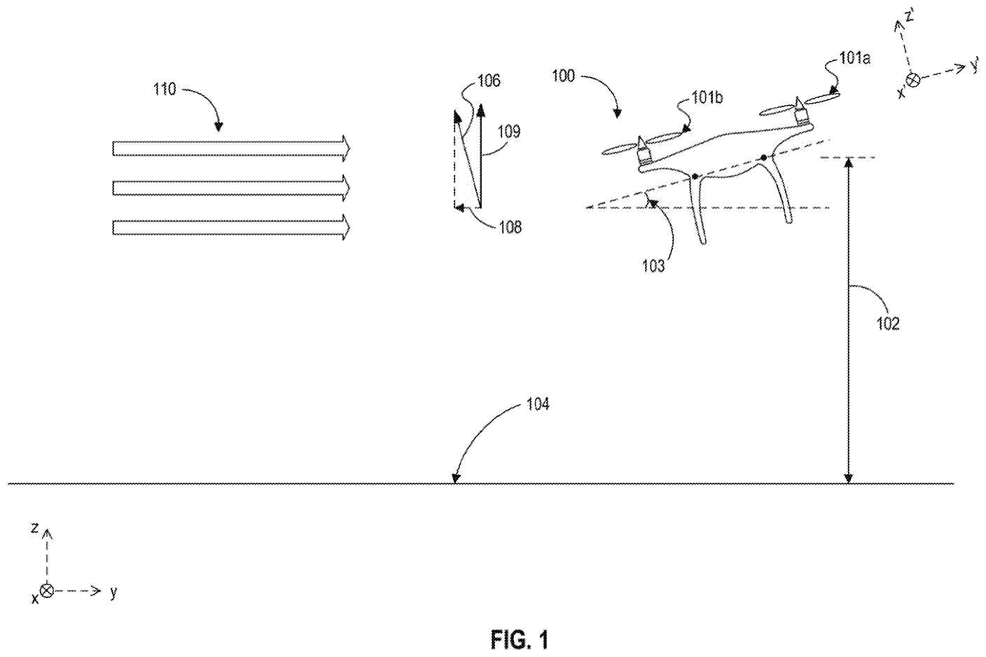

FIG. 1 is a diagram of a use case in which exemplary embodiments of the present disclosure can be used in connection with a movable object 100. For example, movable object 100 may be a multi-copter UAV that is movable using one or more propellers 101a and 101b.

The position, attitude, and movements of movable object 100 may be characterized differently from different perspectives. The earth's or ground frame of reference is labeled as a three-dimensional space with an x-axis, a y-axis, and a z-axis, the x-y plane being parallel to the horizontal ground 104. For example, as shown in the figure, with respect to the earth's frame of reference, movable object 100 is at an altitude 102 above horizontal ground 104, and at an attitude (e.g., with a pitch angle 103) with respect to horizontal ground 104. Movable object 100 is also moving along a direction 106 with horizontal ground speed 108 (with respect to ground 104) and vertical ground speed 109. Movable object 100 is also moving against air currents 110.

At the same time, a coordinate system is also often defined in the movable object's own perspective or frame of reference, and labeled as x′, y′, and z′. In the movable object's coordinate system, movements may consist of lateral and vertical components, the lateral movement being in the plane of the rotations of the propellers and the vertical movement being in the direction perpendicular to the rotation plane. In the present disclosure, the terms “lateral” and “vertical” are defined as such in the coordinate system or reference frame of the movable object. If not otherwise specified, variables without an apostrophe refer to physical properties in the earth's or ground reference frame; variables with an apostrophe refer to physical properties in the movable object's reference frame.

As discussed above, conventional methods, where the attitudes of a UAV are mapped to steady horizontal ground speeds, cannot provide an accurate estimation of the airspeed of an airborne object (like movable object 100) that is undergoing changes in altitude and speed and moving under the influence of air currents. Consistent with embodiments of the present disclosure, estimates of airspeed may be achieved in real time and with better accuracy, as described below in detail.

In a movement with both lateral and vertical components, movable object 100 experiences various forces, including the gravity, so-called H-forces in the lateral direction, thrust T in the vertical direction, and form drag. For ease of discussion, several parameters are defined:
ρ: air density.
m: mass of the movable object.
ω: angular speed of rotation of a propeller.
ωₜ: the sum of all angular speeds of rotation of the propellers.
R: matrix representation of the attitude of the movable object, i.e., the orientation of movable object 100 in the earth's reference frame. It can be represented in as a Direction Cosine Matrix (DCM), or a quaternion, axis-angle, or Euler angles matrix.
v: ground speed, or speed of the movable object with respect to the ground, represented as a three-dimensional vector,

$$[ \begin{matrix}{v}_{x} \\ {v}_{y} \\ {v}_{z}\end{matrix} ] ,$$

in the x-, y-, z-coordinate system (i.e., the earth's reference frame).
w: air current, or the speed of air or air mass, represented as a three-dimensional vector,

$$[ \begin{matrix}{w}_{x} \\ {w}_{y} \\ {w}_{z}\end{matrix} ] ,$$

in the x-, y-, z-coordinate system (i.e., the earth's reference frame). It is also often referred to as the wind speed.
u: airspeed represented as a three-dimensional vector,

$$[ \begin{matrix}{u}_{x} \\ {u}_{y} \\ {u}_{z}\end{matrix} ] ,$$

in the x-, y-, z-coordinate system (i.e., the earth's reference frame). u=v+w.
u′: airspeed u represented in the movable object's reference frame. u′=Ru.
V′: axial airspeed or vertical airspeed, i.e., the vertical component of airspeed in the movable object's reference frame. Thus, V′=e₃^{T}u′, where

$${e}_{3}^{T} = {[ \begin{matrix}0 & 0 & 1\end{matrix} ]}^{T} = [ \begin{matrix}0 \\ 0 \\ 1\end{matrix} ]$$

is the selection matrix that selects the third component, i.e., the z′-axis component of u′.
W′: lateral airspeed, i.e., the lateral component of airspeed in the movable object's reference frame. Thus, W′=S₁₂u′, where

$${S}_{12} = [ \begin{matrix}1 & 0 & 0 \\ 0 & 1 & 0\end{matrix} ]$$

is the selection matrix that selects the first two components, i.e., the x′- and y′-axes components of u′.
   In the context of this specification, although referred to as “speeds,” the airspeed, ground speed, and wind speed are all vectors, with both magnitude and direction components.

The lateral H-forces generated by propellers 101a and 101b can be represented by the following expression:

H′=kρωₜW′=kρωₜS₁₂Ru=kρωₜS₁₂R(v+w) (1),

where k is a scaling constant. Lateral forces also include form drag; but compared to the H-forces, form drag in the lateral plane is much smaller, and can therefore be ignored.

Thrust T′ in the vertical direction depends on the rotation speed and diameter d of propeller and can be expressed as:

T′=C_{T}ρd⁴ω² (2).

C_{T} is the thrust coefficient and depends on axial or vertical airspeed V′ and the propeller speed. C_{T} decreases as vertical airspeed increases.

Form drag in the vertical direction, caused by friction between a surface of the movable object and the air, can be expressed as:

D′=½ρAV′²C_{D} (3),

where A is the reference surface area and C_{D} is a drag coefficient. Thus, the total vertical forces movable object 100 experiences can be expressed as:

F′=D(V′)−ΣᵢT′(ωᵢ,V′) (4),

in which the second component represents a sum thrust of all propellers i.

In expressions (1), (2), and (3), S₁₂, propeller diameter d, and reference surface area A are known constants. Most of the variables can be measured with devices, sensors, or components on board movable object 100. For example, ground speed v can be measured by GPS or an imaging device; attitude matrix R can be determined from readings of the inertia measuring unit (IMU), a gyroscope, or a magnetometer, which can provide information about, for example, an angular rate and an orientation of movable object 100; air density ρ can be measured by a barometric altimeter or a temperature sensor; and propeller rotation speed ω can be measured by an electronic speed control (ESC) module. The ESC module can vary the rotation speeds of electric motors that drive the propellers, and can provide information about the rotation speeds.

An accelerometer can sense the proper acceleration of movable object 100, i.e., acceleration relative to free fall and with gravitational force removed. In other words, if movable object 100 is free falling, the accelerometer measures 0 acceleration. If movable object 100 sits still on a desk, the accelerometer measures an acceleration that corresponds to the force exerted by the desk, which is the gravity's reaction force. Following Newton's Second Law, acceleration so measured can be used to derive the total force experienced by movable object 100. Assuming the measured acceleration is

$${a}^{′} = [ \begin{matrix}{a}_{x}^{′} \\ {a}_{y}^{′} \\ {a}_{z}^{′}\end{matrix} ] ,$$

in the movable object's reference frame, the force experienced by movable object 100 is a vector F′=ma′. Because a′ does not reflect the gravitational force, F′ mainly includes only the H-force (expression (1)), thrust T′ (expression (2)), and vertical form drag D′ (expression (3)).

H-force is only in the lateral direction in the movable object's reference frame, and can be derived from the measured acceleration:

H′=S₁₂F′=mS₁₂a′ (5).

Combined with expression (1), this means

S₁₂a′=k₁ρωₜS₁₂R(v+w) (6).

In expression (6), only the adjusted scaling constant k₁=k/m and wind speed w are unknown.

Likewise, forces in the vertical direction can be expressed using the measured acceleration:

F′_{z′}=e₃^{T}F′=me₃^{T}a′ (7).

Combining (7) with (4) yields (8) below:

me₃^{T}a′=D(V′)−ΣᵢT′(ωᵢ,V′) (8).

Expression (8) can be reduced to (9) below by eliminating the mass element m:

e₃^{T}a′=g(V′)−Σᵢf′(ωᵢ,V′) (9),

where g(V′)=D(V′)/m and Σᵢf′(ωᵢ, V′)=ΣᵢT′(ωᵢ, V′)/m. In expression (9), V′ is unknown. Functions g(V′) and f′(ωᵢ, V′) are also unknown because coefficient C_{D} and the relationship between C_{T} and V′ are unknown.

Consistent with embodiments of the present disclosure, movable object 100 may be calibrated prior to actual flight to determine the scaling constant k₁ in expression (6) and the functions g(V′) and r(ωᵢ, V′) in expression (9), such that, during actual flight, measurements of the various variables can be used to determine the airspeed (hence the wind speed) using those expressions. In one aspect, the scaling constant k₁ can be determined based on a linear regression method. For example, expression (6) can be rewritten as follows:

$${S}_{12} {a}^{′} = [ \begin{matrix}{ρω}_{t} {S}_{12} Rv & {k}_{1} {ρω}_{t} {S}_{12} R\end{matrix} ] [ \begin{matrix}{k}_{1} \\ w\end{matrix} ] \qquad ( {6}^{*} )$$

If we use y to denote S₁₂ a′, Φ to denote [ρωₜS₁₂Rv k₁ρωₜS₁₂R], and θ to denote the unknowns

$$[ \begin{matrix}{k}_{1} \\ w\end{matrix} ] ,$$

then (6*) is simplified as y=Φθ. Instantaneous relationship defined by (6*) can then be represented as yⱼ=Φⱼθⱼ at time j. It is uncommon for the wind speed to change suddenly in either direction or magnitude. Therefore, θ is considered a slow-changing variable compared to the sampling rate of the sensors on movable object 100. As a result, instantaneous measurements of attitude R, air density ρ, propeller rotational speed ωₜ, and ground speed v over time can be used to determine scaling constant k₁, where k₁ is recursively updated over time j. For example, a recursive least squares filter can be applied to expression (6*) to recursively determine k₁. After sufficient data has been generated and applied in the calculation, the value of k₁ should be reliable.

Alternatively, calibration in the lateral direction may be performed in an indoor environment, where wind speed w can be assumed to be zero. In that case, expression (6) is reduced to:

S₁₂a′=k₁ρωₜS₁₂Rv (6*)

Measurements of acceleration a′, sum of rotational speeds ωₜ, density ρ, sum of rotational speeds ωₜ, attitude R, and ground speed v would permit determination of the constant k₁. In the indoor environment, ground speed v may be measured either by onboard sensors or by motion captures equipment. Likewise, a linear regression method can be employed to determine the value of k based on a series of the-mentioned measurements. For example, a set of accelerometer readings, and a set of corresponding values of ρωₜS₁₂Rv, can be collected. A function, based on an estimated value of k₁, for predicting a value of ρωₜS₁₂Rv can be determined, and a value of k₁ that minimizes a squared difference between the predicted and actual values of ρωₜS₁₂Rv can also be determined. Indoor calibration of the lateral movements is much simplified because the wind speed can be assumed to be 0, but it requires a large indoor field to ensure the calibration is reliable at the entire range of lateral speeds.

During the calibration, movable object 100 may be set to move in different directions, such that attitude R and/or ground velocity v, hence Φ or ρωₜS₁₂Rv, change constantly, thereby providing sufficient persistence of excitation and leading to the parameter k₁ converging to a correct and more reliable value. Attitude R, for example, can be changed by movable object 100 constantly turning or changing its yaw, either at a constant rate or at different rates. Also, even though θ is a slow-changing variable, a forgetting factor may be used to give certain weight to historical values in the recursive process.

Once k₁ (hence k) is determined, the value can then be stored (e.g., in a memory included in movable object 100), and can be used to determine, in real-time, the lateral airspeed W′, based on accelerometer readings representing real-time measurements of the H-force (expression (5)), as well as real-time measurements of air density ρ and rotational speed ω.

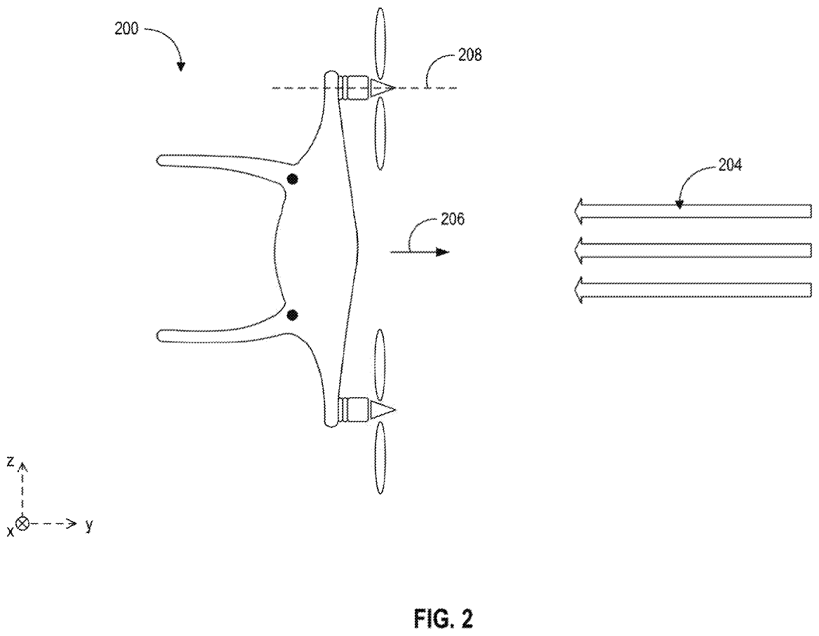

Calibration in the vertical direction may be performed in a wind tunnel. FIG. 2 depicts such a configuration, where movable object 100 is placed vertically against horizontal wind 204. Wind 204 is thus blowing perpendicular to propellers 101a and 101b. During calibration, the wind speed changes, and all propellers are commanded to the same speed that also changes. In such a configuration, the vertical/axial airspeed V′ can be determined based on the wind speed w and the GPS read of the horizontal ground speed v. And for each pair of propeller speed ωⱼ and wind speed w₁, the GPS reading of the ground speed (thus vertical airspeed Vⱼ′) and an accelerometer reading aⱼ are obtained, providing a data triplet (ωⱼ, V′ⱼ, a′ⱼ). Recall expression (9) above:

e₃^{T}a′=g(V′)−Σᵢf′(ωᵢ,V′) (9).

A series of the data triplets (ωⱼ, V′ⱼ, a′ⱼ) can then be used to fit the functions g(V′) and f′(ωⱼ, V′). The determination of g(V′) and f(ωᵢ, V′) can be based on regression method as well.

In some embodiments, calibration in the vertical direction can be performed in an outdoor environment, especially when almost no wind is present. For example, movable object 100 can be projected up into the air and then allowed to ascend and descend. As movable object 100 moves vertically, it may be moving at different vertical airspeeds V′. Different combinations of vertical airspeeds V′ and rotational speeds co may also be generated and mapped to different accelerometer readings a, and functions g(V′), and f(ωᵢ, V′) can be determined accordingly.

Once functions g(V′) and f(ωᵢ, V′) are determined, the accelerometer reading a can then be used to solve the vertical/axial speed V′ as a function of acceleration and the speeds of the propellers:

V=h(a_{z}′,ω₁,ω₂, . . . ,ω_{N}) (10).

Parameters of function h are determined based on parameters representing g(V′) and f(ωᵢ, V′). The parameters of functions h(a_{z}′, ω₁, ω₂, . . . , ω_{N}), g(V′), and f(ωᵢ, V′) can be stored (e.g., in a memory included in movable object 100), and can be used to determine, in real-time, the vertical airspeed based on accelerometer readings representing real-time measurements of the vertical forces experienced by movable object 100 (excluding gravitational pull), as well as real-time measurements of rotational speeds ω₁ . . . ω_{N} and air density ρ.

During actual flight, the calibrated results are used to determine lateral airspeed W′ and vertical airspeed V′. Then the 3-dimensional airspeed u′ can be determined based on the two. From u′, the airspeed u in the earth's can be determined as u=R⁻¹u′. With u and the GPS read of the ground speed v, the wind speed w can also be determined as u−v.

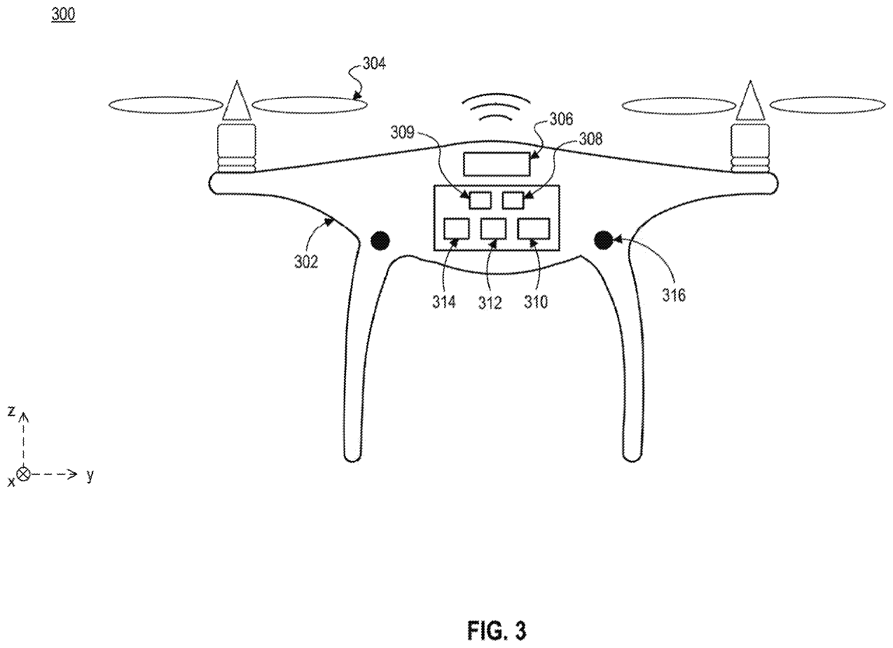

Reference is now made to FIG. 3, which is a diagram of an exemplary system 300 for performing one or more operations in accordance with the disclosed embodiments. System 300 may include a housing 302 and one or more propellers 304. Housing 302 may house mechanical components such as motors and actuators to control the motions of propellers 304. Housing 302 may also house electronic components, such as a GPS receiver 306 configured to receive GPS signals for location determination, an electronic speed control module 308 configured to determine angular speed of rotation of propellers 304, an altimeter 309 configured to provide a measurement of altitude of system 300, an air pressure and temperature sensor 310 configured to provide information about air density (based on, e.g., air pressure and temperature), and an attitude detection unit 312 configured to provide information about an attitude (at least one of the yaw, pitch, and roll angle) of system 300. Attitude detection unit 312 may include, for example, a magnetometer, a gyroscope, and/or an IMU. Housing 302 may also include one or more accelerometers 314 configured to measure a force received by system 300 along the x-axis, y-axis, and z-axis. Housing 302 may also house one or more video cameras 316 configured to provide image data for various applications, such as collision avoidance, ground speed determination (e.g., by tracking change of the size of an object with respect to time), etc.

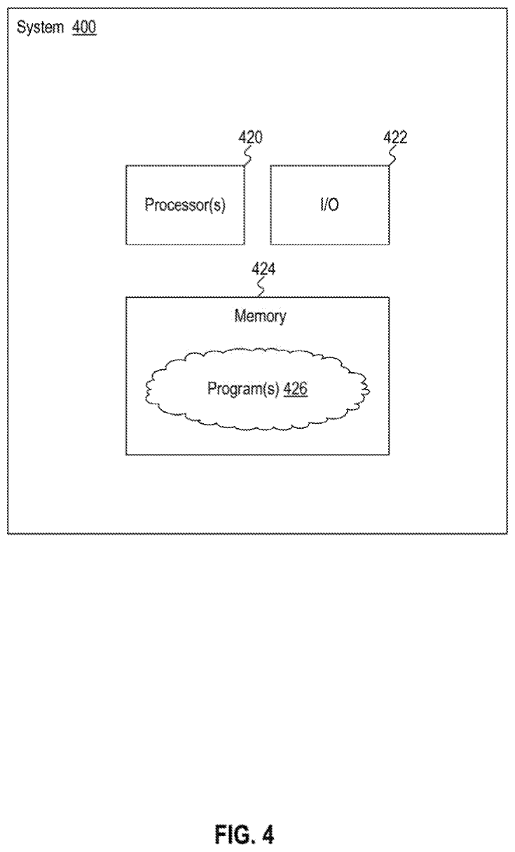

Housing 302 may also house a controller system that includes one or more processors, one or more input/output (I/O) devices, and one or more memories. FIG. 4 shows a schematic block diagram of an exemplary controller system 400 that may be used in accordance with the disclosed embodiments. System 400 may include one or more processors 420, one or more I/O devices 422, and one or more memories 424. In some embodiments, system 400 may take the form of a mobile computing device, general-purpose computer, etc., for performing one or more operations consistent with the disclosed embodiments.

Processor 420 may include one or more known processing devices. For example, the processor may be from the family of processors manufactured by Intel, from the family of processors manufactured by Advanced Micro Devices, or the like. Alternatively, the processor may be based on the ARM architecture. In some embodiments, the processor may be a mobile processor. The disclosed embodiments are not limited to any particular type of processor.

I/O devices 422 may be one or more devices configured to allow data to be received and/or transmitted by the controller 410. The I/O devices 422 may include one or more communication devices and interfaces, and any necessary analog-to-digital and digital-to-analog converters, to communicate with and/or control other mechanical components and devices, such as propellers 304, GPS receiver 306, altimeter 309, barometer and temperature sensor 310, attitude detection unit 312, accelerometers 314, and video cameras 316.

Memory 424 may include one or more storage devices configured to store software instructions used by the processor 420 to perform functions related to the disclosed embodiments. For example, the memory 424 may be configured to store software instructions, such as program(s) 426 that performs one or more operations when executed by processor(s) 420. For example, memory 424 may include a single program 426, such as a user-level application, that performs the functions of the disclosed embodiments, or may comprise multiple software programs. Additionally, the processor 420 may execute one or more programs (or portions thereof) remotely located from the controller 410. Furthermore, memory 424 also may be configured to store data, for example, for use by the software program(s) 426.

In some embodiments, systems 300 and 400 can be configured as movable object 100 of FIGS. 1-2, and software program(s) 426 can include one or more software modules that, when executed by controller system 400, perform a method of determining an airspeed of movable object 100 based on its ground speed and one or more forces received by movable object 100, consistent with embodiments of the present disclosure.

For example, referring back to FIGS. 1-2, software program(s) 426 can include one or more software modules configured to execute a first calibration mode for horizontal airspeed determination, under which software program(s) 426 can control movable object 100 to move at a certain speed and a certain attitude (e.g., with a pitch angle 103) with respect to horizontal ground 104. The software modules may include electronic speed control module 308 and can control the relative rotation speeds of propellers 304, in order to control the direction, airspeed, attitude and altitude of movable object 100. Software program(s) 426 can interact with accelerometers 314 to collect samples of the H-forces received by control movable object 100. Software program(s) 426 can also interact with, for example, GPS receiver 306 and/or video camera 316 to generate location data, and to generate samples of the ground speed of movable object 100. Software program(s) 426 can also interact with, for example, barometer and temperature sensor 310 and attitude detection unit 312, to obtain measurement samples of, for example, air density and attitude. Software program(s) 426 can also perform, for example, a recursive least squares method (RLS), or a least square estimation algorithm using the collected samples, as well as the known rotational speeds of the propellers, to determine a relationship between H-force and horizontal airspeed, as represented in expressions (1), (6*), and (6**). The relationship can be represented in the form of a scaling factor k, which can be stored in memory 424. After the first calibration mode completes, software program(s) 426 can then determine a horizontal airspeed based on the stored scaling factor k and new samples of H-forces, air density, attitude, and propellers' rotational speeds.

Moreover, software program(s) 426 can include one or more software modules configured to execute a second calibration mode for vertical airspeed determination. For example, software program(s) 426 can control movable object 100 to move along a vertical direction with the propellers rotating at a predetermined rotational speed. Software program(s) 426 can also control movable object 100 to move within a wind tunnel such that a rotation axis of the propellers align with the wind direction. In both cases, software program(s) 426 can acquire different combinations of accelerometer reading, propellers rotational speeds, and airspeeds, and then perform an algorithm of regression method to determine the parameters representing g(V′) and Σᵢf′(ωᵢ, V′) in expression (9), h(a_{z}′, ω₁, ω₂, . . . , ω_{N}) in expression (10), and store the parameters in memory 424. After the second calibration mode completes, software program(s) 426 can then determine vertical airspeed based on the stored parameters and new samples of accelerometer readings, attitude, air density, and propellers' rotational speeds.

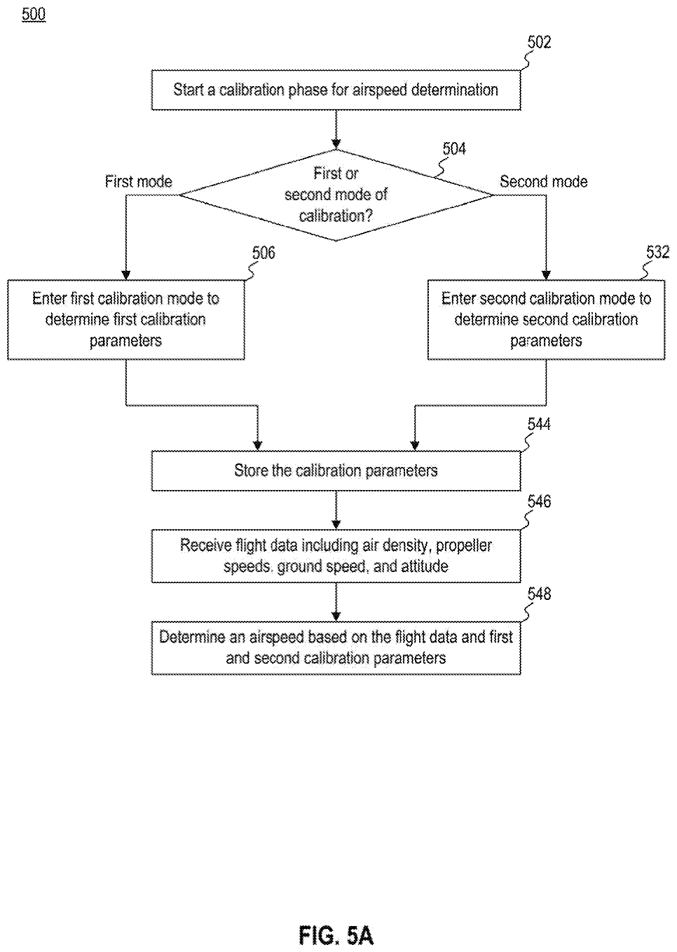

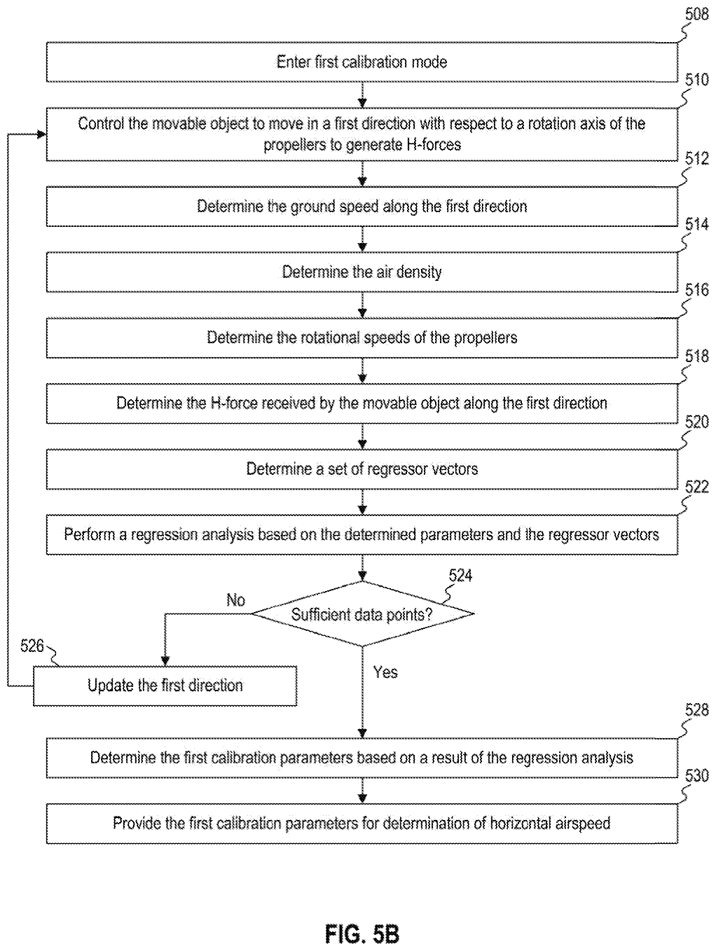

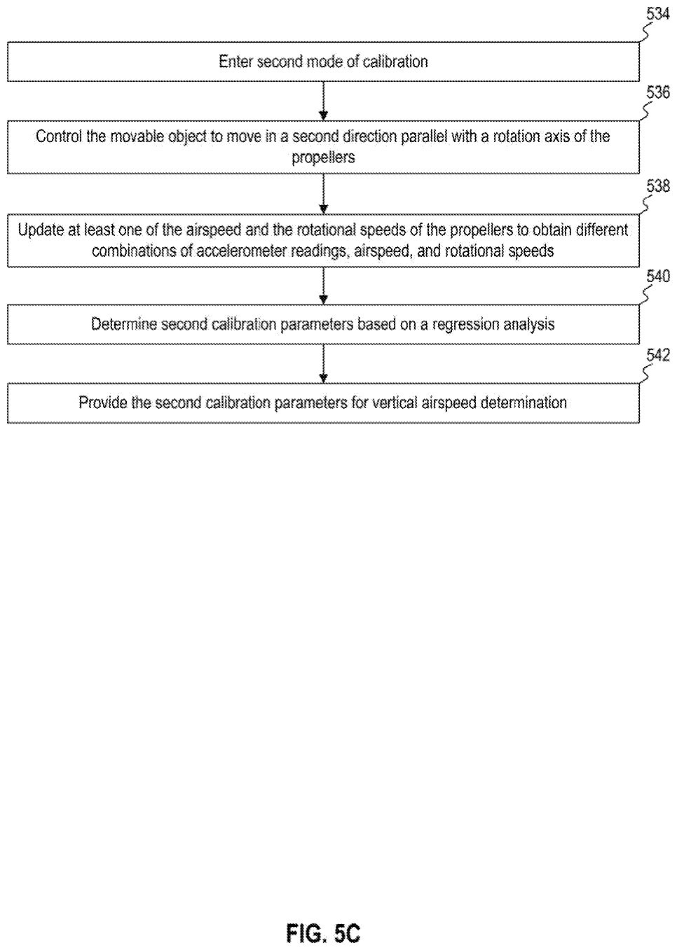

Reference is now made to FIG. 5A, which illustrates steps of an exemplary process 500 for determining the airspeed of a movable object based on the ground speed of the movable object and one or more forces received by the movable object, according to embodiments of the present disclosure. The process may be implemented in software, hardware, or any combination thereof. For purposes of explanation and not limitation, process 500 will be described in the context of systems 300 and 400, such that the disclosed process may be performed by software executing in controller system 400 and/or movable object 100.

In step 502, the system determines to start a calibration phase for airspeed determination. The determination to start a calibration phrase can be triggered by different events. For example, the system may determine to start a calibration phase when the system just starts up, or that the system has not been airborne for a predetermined amount of time (e.g., a week), etc.

After determining to start a calibration phase, the system proceeds to step 504 to determine whether to proceed with a first calibration mode (for horizontal airspeed determination) or to proceed with a second calibration mode (for vertical airspeed determination). In some embodiments, the system may be configured to first proceed with the first calibration mode followed by the second calibration mode, or vice versa. In some embodiments, the system may also determine to forgo the second calibration mode, if the air current direction is mostly parallel with the ground. In that case, the system may determine the vertical airspeed based on the horizontal airspeed (after first calibration mode completes) and the attitude of the movable object. For example, the system may determine an airspeed of the movable object based on a projection of the horizontal airspeed onto the direction of motion of the movable object (determined based on the attitude), and then projecting the airspeed onto vertical z-axis to determine the vertical airspeed.

After determining to proceed with the first calibration mode in step 504, the system can then proceed to step 506 and perform the first mode of calibration to determine first calibration parameters. Reference is now to FIG. 5B, which illustrate a sequence of steps for the first mode of calibration, according to embodiments of the present disclosure. After entering the first calibration mode, in step 508, the system proceeds to step 510 and controls the movable object to move in a first direction with respect to a rotation axis of the propellers to generate H-forces. For example, referring back to FIG. 1, the system may control the movable object to move along a direction parallel to the horizon, with a pitch angle 103.

While the movable object moves in the first direction, the system also determines the ground speed along the first direction based on, for example, location information provided by the GPS or determined based on video image data, in step 512. The system also determines the air density based on, for example, barometer and temperature sensor data, in step 514. The system also determines the rotational speeds of the propellers in step 516, and the H-force received by the movable object along the first direction in step 518. In steps 512-518, multiple samples of these parameters can be acquired at different time points. After acquiring the samples of these parameters when the movable object is moving in the first direction, the system then proceed to step 520 to determine a set of regressor vectors based on the determined parameters.

After determining the regressor vectors, the system may then perform a regression analysis, using the regressor vectors, to determine a relationship between the H-force and the airspeed, in step 522. As discussed above, the determination can be based on, for example, recursive least squares method (if both wind speed and the constant k are unknown) or least square estimation (if the wind speed can be assumed zero). Based on a result of step 518, the system can then determine whether there are sufficient data points to perform the analysis. The sufficiency can be determined based on, for example, whether there is a convergence to a certain degree between a predicted model and the determined parameters, whether a range of the determined parameters satisfies a predetermined threshold, etc.

If the system determines that there are not sufficient data points, in step 524, the system may proceed to step 526 and update the first direction. For example, the system may change a yaw angle of the movable object, and then repeat steps 510-522 to acquire more data points for the regression analysis. On the other hand, if the system determines that the data points are sufficient, in step 526, the system can then proceed to step 528 and determine the first calibration parameters based on a result of the regression analysis. The first calibration parameters may include, for example, a constant k that relates the H-force to airspeed, according to expression (1). The system can then provide the first calibration parameters for determination of horizontal airspeed, in step 530.

Referring back to FIG. 5A, if in step 504 the system determines to perform the second mode of calibration for determination of vertical airspeed, the system may proceed to step 532 and perform the second mode of calibration to determine first calibration parameters.

Reference is now made to FIG. 5C, which illustrate a sequence of steps for the second mode of calibration, according to embodiments of the present disclosure. As it enters the second mode of calibration, in step 534, the system can control the movable object to move in a second direction parallel with a rotation axis of the propellers, in step 536. For example, movable object 100 may be controlled to move vertically and parallel with the rotational axis of the propellers 101a and 101b, or horizontally and still parallel to the rotation axis of the propellers 101a and 101b (e.g., in direction 208 in FIG. 2).

When the movable object is moving along the second direction, the system can proceed to step 538 and control the rotational speeds of the propellers, to obtain different combinations of accelerometer readings (which represent a force received by the movable object along the second direction), airspeeds, and rotational speeds. For example, the movable object may be descending vertically in an outdoor environment and experiences an increase in vertical airspeed. During the descending, the system can change the rotational speed of the propellers, and obtain samples, from an accelerator, of measurements of the vertical force (excluding the gravitational pull) experienced by the movable object. Moreover, the movable object may also be moving horizontally in a wind tunnel, where the wind speed (and the airspeed) is adjusted, and the rotational speed of the propellers are also adjusted, to create different combinations of accelerometer readings, airspeeds, and rotational speeds.

After combinations of accelerometer readings, airspeeds, and rotational speeds are collected, the system can proceed to step 540 to perform regression analysis to determine second calibration parameters representing a relationship between the vertical airspeed and a combination of accelerometer readings and propellers rotational speeds. For example, the system may determine parameters representing g(V′) and Σᵢf′(ω₁, V′) in expression (9), h(a_{z}′, ω₁, ω₂, . . . , ω_{N}) in expression (10). After determining the second calibration parameters in step 540, the system can then proceed to step 542 and provide the second calibration parameters for vertical airspeed determination.

Referring back to FIG. 5A, after the first and second calibration parameters are determined, the system can proceed to step 544 and store the calibration parameters. The system may receive new flight data including air density, propeller speeds, ground speed, and attitude, in step 546, and then determine a horizontal airspeed (along the x′-y′ plane) and vertical airspeed (along the z′ axis) based on the new flight data and the calibration parameters, in step 548.

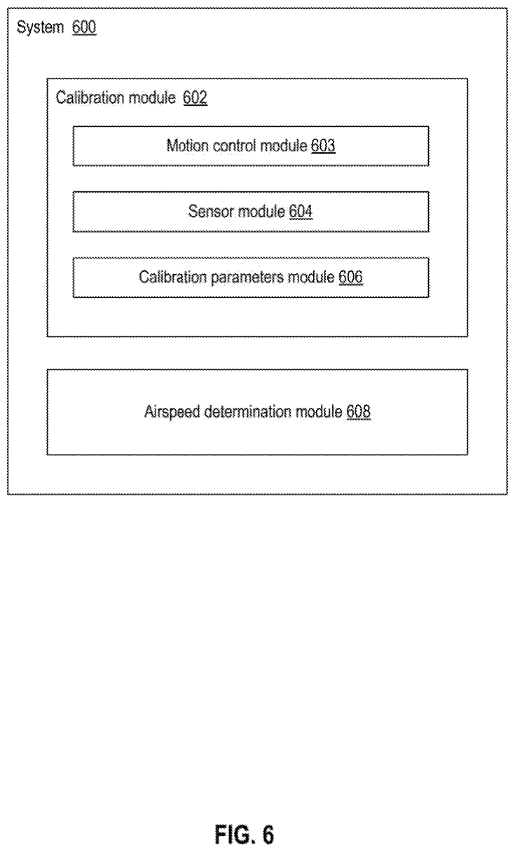

Reference is now made to FIG. 6, which is a schematic block diagram of an exemplary system 600 for determining the airspeed of a movable object based on the ground speed of the movable object and one or more forces received by the movable object, according to embodiments of the present disclosure. As shown in FIG. 6, system 600 includes a calibration module 602, which includes a motion control module 603, a sensor module 604, and a calibration parameters module 606. System 600 also includes an airspeed determination module 608.

For the purposes of this disclosure, “modules” may be implemented in software, hardware, firmware, a mix of any of those, or the like. For example, if the disclosed “modules” are implemented in software, they may be stored in memory 424 of system 400 as components of program(s) 426, and include code instructions executable by one or more processors, alone or in various combinations with other modules disclosed in this or other embodiments. On the other hand, the disclosed “modules” can also be implemented in hardware such as, for example, application specific integrated circuits (ASIC), field-programmable gate array (FPGA), etc. System 600 may be housed in, for example, movable object 100.

In some embodiments, calibration module 602 is configure to cause a movable object to enter a calibration mode, in which calibration parameters for horizontal and vertical airspeed determination can be determined. In some embodiments, calibration module 602 is configured to perform, for example, steps 502 and 504 of FIG. 5A.

In some embodiments, motion control module 603, which can be a part of calibration module 602, is configured to control a motion of the movable object based on the calibration mode, and to update, for example, a direction of motion, rotational speeds of the propellers, etc. In some embodiments, motion control module 603 is configured to perform, for example, steps 510 and 526 of FIG. 5B, and steps 536 and 538 of FIG. 5C.

In some embodiments, sensor module 604, which can be a part of calibration module 602, is configured to acquire flight data of the movable object, which can include, for example, air density, propeller speeds, ground speed, and attitude of the movable object, as well as one or more forces received by the movable object. In some embodiments, sensor module 604 is configured to perform, for example, steps 512-518 of FIG. 5A, and step 538 of FIG. 5B.

In some embodiments, calibration parameters module 606 is configured to determine calibration parameters for horizontal and vertical airspeed determination. The determination may include regression analysis and based on the flight data acquired by sensor module 604. In some embodiments, calibration parameters module 606 is configured to perform, for example, steps 520-524 and 528 of FIG. 5B, and step 540 of FIG. 5C.

In some embodiments, airspeed determination module 608 is configured to determine an airspeed of the movable object based on the calibration parameters provided by calibration parameters module 606, as well as new flight data acquired by sensor module 604. In some embodiments, airspeed determination module 608 is configured to perform, for example, steps 544 and 548 of FIG. 5A.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. It is to be understood that the examples and descriptions in this disclosure have been arbitrarily defined herein for the convenience of the description. The disclosed systems and methods are not limited to these simplified examples, and other features and characteristics may be considered so long as the specified functions are appropriately performed.

While certain disclosed embodiments have been discussed with respect to UAVs for purposes of discussion, one skilled in the art will appreciate the useful applications of disclosed methods and systems for identifying target objects. Furthermore, although aspects of the disclosed embodiments are described as being associated with data stored in memory and other tangible computer-readable storage mediums, one skilled in the art will appreciate that these aspects can be stored on and executed from many types of tangible computer-readable media. Further, certain processes and steps of the disclosed embodiments are described in a particular order, one skilled in the art will appreciate that practice of the disclosed embodiments are not so limited and could be accomplished in many ways. Accordingly, the disclosed embodiments are not limited to the above-described examples, but instead are defined by the appended claims in light of their full scope of equivalents.

What is claimed is:

1. A method of determining airspeed of a movable object, comprising:
performing a calibration process to determine a relationship between forces exerted on the movable object and airspeed of the movable object;
determining forces exerted on the movable object while the movable object is moving; and
determining, based on the determined forces and the relationship, an airspeed of the movable object.

2. The method of claim 1, wherein the calibration process comprises determining a relationship between forces exerted on the movable object in a lateral direction and lateral airspeed of the movable object.

3. The method of claim 1, wherein the calibration process comprises determining a relationship between forces exerted on the movable object in a vertical direction and vertical airspeed of the movable object.

4. The method of claim 1, wherein the calibration process comprises:
determining a relationship between forces exerted on the movable object in a lateral direction and lateral airspeed of the movable object; and
determining a relationship between forces exerted on the movable object in a vertical direction and vertical airspeed of the movable object.

5. The method of claim 1, wherein the calibration process comprises:
a) controlling the movable object to move in a first direction;
b) adjusting a speed of the movable object in the first direction;
c) detecting an acceleration of the movable object along the first direction;
d) detecting flight parameters, including at least one of air density, rotation speeds of one or more propellers, attitude of the movable object, or ground speed of the movable object; and
e) determining calibration parameters representing a relationship between the forces and the airspeed in the first direction based on the detected acceleration and the detected flight parameters.

6. The method of claim 5, wherein the calibration process further comprises repeating steps b) through d), wherein determining the calibration parameters in step e) is based on the detected acceleration and the detected flight parameters in repeated steps b) through d).

7. The method of claim 5, wherein detecting the acceleration comprises detecting with an accelerometer.

8. The method of claim 5, wherein detecting the attitude comprises detecting with an attitude detection unit that includes at least one of a magnetometer, a gyroscope, or an inertial measurement unit.

9. The method of claim 5, wherein detecting the air density comprises detecting with a barometer.

10. The method of claim 5, wherein detecting the rotation speeds of the one or more propellers comprises detecting with an electronic speed control module that controls the one or more propellers.

11. The method of claim 5, wherein detecting the ground speed comprises detecting with a speed measurement module

12. The method of claim 1:
wherein the calibration process comprises determining a relationship in a lateral direction and a relationship in a vertical direction;
wherein determining the forces exerted on the movable object comprises determining the forces in both the lateral direction and the vertical direction;
wherein determining the airspeed comprises 1) determining lateral airspeed based on the forces and relationship in the lateral direction, 2) determining vertical airspeed based on the forces and relationship in the vertical direction; and 3) constructing the airspeed based on the lateral airspeed and the vertical airspeed.

13. A movable object, comprising:
a memory storing a relationship between airspeeds and forces exerted on the movable object;
a first sensor that senses forces exerted on the movable object; and
a processor configured to determine an airspeed of the movable object based on the relationship and the sensed forces on the movable object.

14. The movable object of claim 13, wherein the relationship stored in the memory comprises a relationship between forces exerted on the movable object in a lateral direction and lateral airspeed of the movable object.

15. The movable object of claim 13, wherein the relationship stored in the memory comprises a relationship between forces exerted on the movable object in a vertical direction and vertical airspeed of the movable object.

16. The movable object of claim 13, wherein the relationship stored in the memory comprises a relationship between forces exerted on the movable object in a lateral direction and lateral airspeed of the movable object, and a relationship between forces exerted on the movable object in a vertical direction and vertical airspeed of the movable object.

17. The movable object of claim 13, further comprising a second sensor that senses flight parameters, including at least one of acceleration of the movable object, air density, rotation speeds of one or more propellers, attitude of the movable object, or ground speed of the movable object, wherein the relationship is determined based on the flight parameters.

18. The movable object of claim 17, wherein the relationship in the memory is determined based on the flight parameters sensed while the movable object moves at varying speeds and/or in varying directions.

19. The movable object of claim 13, wherein the processor is configured to:
determine lateral airspeed based on the forces and the relationship,
determine vertical airspeed based on the forces and the relationship; and
construct the airspeed based on the lateral airspeed and the vertical airspeed.

20. A movable object, comprising:
one or more propellers;
an electronic speed control module configured to determine rotational speeds of the one or more propellers;
an accelerometers configured to detect one or more forces received by the movable object;
an attitude detection unit that includes at least one of a magnetometer, a gyroscope, or an inertial measurement unit;
a barometer configured to provide information for determination of air density;
a memory storing a relationship between airspeeds and forces exerted on the movable object; and
a processor configured to determine an airspeed of the movable object based on the relationship, the detected forces, the rotation speeds, an attitude detected by the attitude detection unit.
